(19) United States
(12) Patent Application Publication
(10) Pub. No.: US 2026/0228105 A1
(43) Pub. Date: Aug. 6, 2026

(54) SOLUTION FOR GENERATING STORAGE DEVICE FIRMWARE SYSTEM DATA FOR TARGET ALGORITHMS EVALUATION

(71) Applicant: SK hynix Inc., Gyeonggi-do (KR)

(72) Inventors: Igor NOVOGRAN, Wroclaw (PL); Dmitri ZELENIAK, Gdansk (PL)

(21) Appl. No.: 19/046,617

(22) Filed: Feb. 6, 2025

(51) Int. Cl. G06F 11/34; G06F 11/30

(52) U.S. Cl. CPC G06F 11/3457; G06F 11/3034; G06F 11/3414

(57) ABSTRACT

A method of simulating an operation of a nonvolatile memory device in a steady state is provided. The method initializes a target set of system data (TSSD) by simulating the steady state. The method mimics an access to the TSSD by simulating a target workload of the nonvolatile memory device in the simulated steady state with a reduced image (RI) for the TSSD.

### BACKGROUND

### 1. Field

Embodiments of the present disclosure relate to a solution for storage device simulation.

### 2. Description of the Related Art

The computer environment paradigm has shifted to ubiquitous computing systems that can be used anytime and anywhere. As a result, the use of portable electronic devices such as mobile phones, digital cameras, and notebook computers has rapidly increased. These portable electronic devices generally use a memory system having a memory device(s), that is, a data storage device(s). The data storage device is used as a main memory device or an auxiliary memory device of the portable electronic devices.

Memory systems using memory devices provide excellent stability, durability, high information access speed, and low power consumption, since the memory devices have no moving parts. Examples of memory systems having such advantages include universal serial bus (USB) memory devices, memory cards having various interfaces such as a universal flash storage (UFS), and solid-state drives (SSDs). Memory systems may be tested using various test tools including simulation.

### SUMMARY

In one embodiment of the present disclosure, a method of simulating an operation of a nonvolatile memory device in a steady state may be provided. The method may initialize a target set of system data (TSSD) by simulating the steady state. The method may mimic an access to the TSSD by simulating a target workload of the nonvolatile memory device in the simulated steady state with a reduced image (RI) for the TSSD. The TSSD may be one or more system data entities (SDEs) affected by one or more of the target workload and a target precondition. Each of the SDEs may be one or more of a set of counters including at least one of an erase counter and read counter, which control one or more physical states of the nonvolatile memory device during a lifetime of the nonvolatile memory device, a logical-to-physical (L2P) table and a physical-to-logical (P2L) table for managing physical access to data stored in the nonvolatile memory device. The RI may be a set of one or more reduced entities (REs), each of which is a set of one or more numerical values representing the TSSD. The target workload may be one or more operations of accessing the nonvolatile memory device in the simulated steady state. The target precondition may be a predetermined number of operations of accessing the nonvolatile memory device to simulate the steady state.

The method may further include measuring, as a target metric, a requirement for the nonvolatile memory device in the simulated steady state as a result of the mimicking.

The requirement may include at least one of quality of service (QoS), throughput, power consumption, data reliability and command latency distribution of the nonvolatile memory device in the simulated steady state.

The initializing may include defining the target metric, the target precondition and the target workload.

The initializing further includes defining a ‘k’ number of firmware algorithms with indices {i₁, . . . , iₖ} to be executed during the target workload; defining an ‘l’ number of SDEs with indices {j₁, . . . , jₗ} to be utilized by the ‘k’ number of firmware algorithms with indices {i₁, . . . , iₖ} during the target workload; selecting, as the TSSD, a set of a ‘p’ number of SDEs with indices {s₁, . . . , sₚ} for the target precondition from the ‘l’ number of SDEs with indices {j₁, . . . , jₗ}; selecting, according to the TSSD, a ‘t’ number of firmware algorithms with indices {a₁, . . . , aₜ} from the ‘k’ number of firmware algorithms with indices {i₁, . . . , iₖ}; replacing the TSSD with the RI; and initializing the RI.

The mimicking may include defining information representing at least one of an identifier of a firmware algorithm selected from the ‘t’ number of firmware algorithms with indices {a₁, . . . , aₜ}, a request type for accessing at least one SDE selected from the ‘p’ number of SDEs with indices {s₁, . . . , sₚ}, an identifier of the selected SDE from the ‘p’ number of SDEs with indices {s₁, . . . , sₚ}, and a value for updating the selected SDE.

The mimicking may include simulating the target workload according to the defined information.

The mimicking may further include updating the RI as a result of the simulating of the target workload.

In another embodiment of the present disclosure, a memory system may include a nonvolatile memory device and a control circuitry configured to simulate an operation of a nonvolatile memory device in a steady state by initializing a target set of system data (TSSD) by simulating the steady state, and mimicking an access to the TSSD by simulating a target workload of the nonvolatile memory device in the simulated steady state with a reduced image (RI) for the TSSD. The TSSD may be one or more system data entities (SDEs) affected by one or more of the target workload and a target precondition. Each of the SDEs may be one or more of a set of counters including at least one of an erase counter and read counter, which control one or more physical states of the nonvolatile memory device during a lifetime of the nonvolatile memory device, a logical-to-physical (L2P) table and a physical-to-logical (P2L) table for managing physical access to data stored in the nonvolatile memory device. The RI may be a set of one or more reduced entities (REs), each of which is a set of one or more numerical values representing the TSSD. The target workload may be one or more operations of accessing the nonvolatile memory device in the simulated steady state. The target precondition may be a predetermined number of operations of accessing the nonvolatile memory device to simulate the steady state.

The control circuitry may simulate the operation further by measuring, as a target metric, a requirement for the nonvolatile memory device in the simulated steady state as a result of the mimicking.

The requirement may include at least one of quality of service (QoS), throughput, power consumption, data reliability and command latency distribution of the nonvolatile memory device in the simulated steady state.

The initializing may include defining the target metric, the target precondition and the target workload.

The initializing further includes defining a ‘k’ number of firmware algorithms with indices {i₁, . . . , iₖ} to be executed during the target workload; defining an ‘l’ number of SDEs with indices {j₁, . . . , jₗ} to be utilized by the ‘k’ number of firmware algorithms with indices {i₁, . . . , iₖ} during the target workload; selecting, as the TSSD, a set of a ‘p’ number of SDEs with indices {s₁, . . . , sₚ} for the target precondition from the ‘l’ number of SDEs with indices {j₁, . . . , jₗ}; selecting, according to the TSSD, a ‘t’ number of firmware algorithms with indices {a₁, . . . , aₜ} from the ‘k’ number of firmware algorithms with indices {i₁, . . . , iₖ}; replacing the TSSD with the RI; and initializing the RI.

The mimicking may include defining information representing at least one of an identifier of a firmware algorithm selected from the ‘t’ number of firmware algorithms with indices {a₁, . . . , aₜ}, a request type for accessing at least one SDE selected from the ‘p’ number of SDEs with indices {s₁, . . . , sₚ}, an identifier of the selected SDE from the ‘p’ number of SDEs with indices {s₁, . . . , sₚ}, and a value for updating the selected SDE.

The mimicking may include simulating the target workload according to the defined information.

The mimicking may further include updating the RI as a result of the simulating of the target workload.

Additional embodiments of the present disclosure will become apparent from the following description.

### BRIEF DESCRIPTION OF THE DRAWINGS

FIG. 1 is a block diagram illustrating a flash-based device in accordance with an embodiment of the present disclosure.

FIG. 2 is a circuit diagram illustrating a memory block of a storage in accordance with an embodiment of the present disclosure.

FIG. 3 is a diagram illustrating a logical structure of a flash-based device and firmware with a target set of system data manager in accordance with an embodiment of the present disclosure.

FIG. 4 is a flowchart illustrating an operation of host write processing in accordance with an embodiment of the present disclosure.

FIG. 5 is a flowchart illustrating an operation of garbage collection write processing in accordance with an embodiment of the present disclosure.

FIG. 6 is a flowchart illustrating an operation of host read processing in accordance with an embodiment of the present disclosure.

### DETAILED DESCRIPTION

Various embodiments of the present disclosure are described below in more detail with reference to the accompanying drawings. The embodiments of the present disclosure may, however, be embodied in different forms and thus should not be construed as limited to the embodiments set forth herein. Rather, these embodiments are provided so that this disclosure conveys the scope of the present disclosure to those skilled in the art. Moreover, reference herein to “an embodiment,” “another embodiment,” or the like is not necessarily to only one embodiment, and different references to any such phrase are not necessarily to the same embodiment(s). The term “embodiments” as used herein does not necessarily refer to all embodiments. Throughout this disclosure, like reference numerals refer to like parts in the figures and embodiments of the present disclosure.

The present disclosure can be implemented in numerous ways, including as a process; an apparatus; a system; a computer program product embodied on a computer-readable storage medium;

and/or a processor, such as a processor suitable for executing instructions stored on and/or provided by a memory coupled to the processor. In this specification, these implementations, or any other form that the present disclosure may take, may be referred to as embodiments. In general, the order of the operations of disclosed processes may be altered within the scope of the present disclosure. Unless stated otherwise, a component such as a processor or a memory described as being suitable for performing a task may be implemented as a general device or circuit component that is configured or otherwise programmed to perform the task at a given time or as a specific device or circuit component that is manufactured to perform the task. As used herein, the term ‘processor’ or the like refers to one or more devices, circuits, and/or processing cores suitable for processing data, such as computer program instructions.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described herein, the code or instructions for implementing the operations of the method embodiments may transform the computer, processor, controller, or other signal processing device into a special-purpose processor for performing methods herein.

When implemented in software, the memory (or other storage devices), controllers, processors, devices, modules, units, multiplexers, generators, logic, interfaces, decoders, drivers, generators and other signal generators and signal processors shown in the drawings (unless otherwise denoted) comprise simulation entities (i.e., software code) that simulate activities and behavior of those components. Since the present disclosure relates to software simulation, no actual hardware is needed although (in one embodiment) input parameters for the simulations may be provided by actual hardware devices. Accordingly, the system components depicted in the accompanying drawings refer to program code parts used for the simulations. For example, to estimate the performance of a solid-state drive SSD, software-based models of the particular component product parts of the SSD (memory, CPU, firmware, host controller and even the operational system) can be created. Such models simulate the activities of the named parts. That is, in one embodiment of the present disclosure, the models investigate the impact of parametric variations on characteristics/metrics of the simulated component. For more detailed simulations, the components can be represented by more simulation entities to simulate the processes more exactly. The software models do not need an actual (physical) device for operation.

A detailed description of embodiments of the present disclosure is provided below along with accompanying figures that illustrate aspects of the present disclosure. The scope of the present disclosure is described in connection with such embodiments, but the present disclosure is not limited to any specific embodiment. The present disclosure encompasses numerous alternatives, modifications and equivalents. Numerous specific details are set forth in the following description in order to provide a thorough understanding of the present disclosure. These details are provided for the purpose of example; the present disclosure may be practiced according to the claims without some or all of these specific details. For clarity, technical material that is known in technical fields related to the present disclosure has not been described in detail so that the present disclosure is not unnecessarily obscured.

A non-volatile memory storage device based on, for example, NAND Flash memory (e.g., SSD), is a complex system where hardware and firmware interact together. Final storage device characteristics (e.g., performance (latency and throughput), reliability, etc.) depend on designed hardware components, implemented firmware algorithms and their parameters. Taking into account the variability in customer requirements and target workloads, storage device tuning is becoming an important part of the product development process.

The tuning for real storage devices adds a considerable time overhead to the development process and allocates many resources, especially for drive end-of-life conditions. One of the possible solutions to reduce this overhead is to use simulation models of a storage device, for example, for what-if analysis, tuning, bottleneck search, and an algorithm verification. Simulation in theory should reduce the time needed to “tune” storage device prototypes and can provide a cost-effective solution for predicting storage device characteristics and for verifying firmware algorithms and prototype changes.

As both hardware and firmware layers are contributors of storage device characteristics, in one embodiment of the present disclosure, both hardware and firmware components can be simulated not only at the early product development design stage but also at the later stages in the product design to find weak points and improvements of firmware algorithms, and may even be used with measurements from actual products to tune the simulation settings and/or to discover possible performance issues especially during product development.

### Hardware and Firmware Components

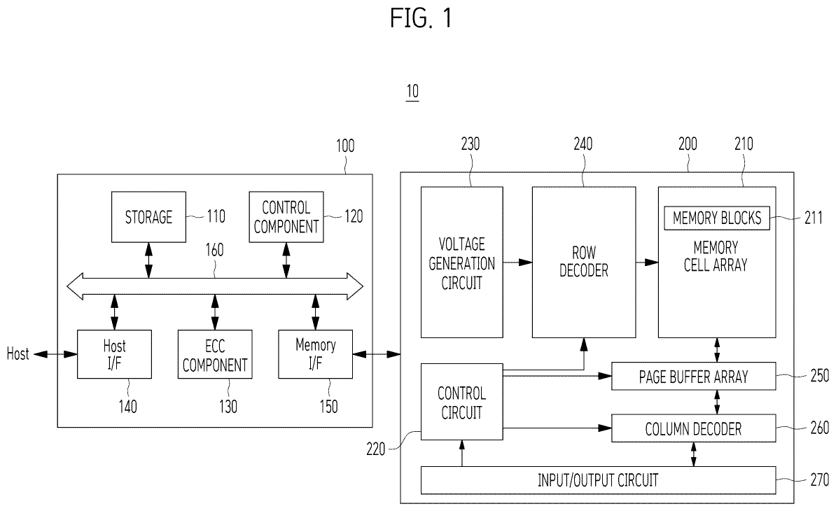

FIG. 1 is a block diagram illustrating a flash-based device 10 in accordance with an embodiment of the present disclosure.

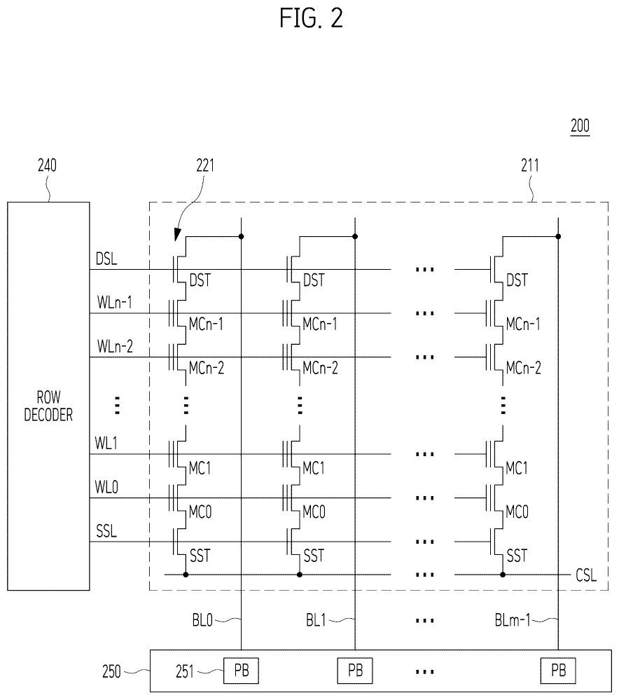

FIG. 2 is a circuit diagram illustrating a memory block of a storage in accordance with an embodiment of the present disclosure.

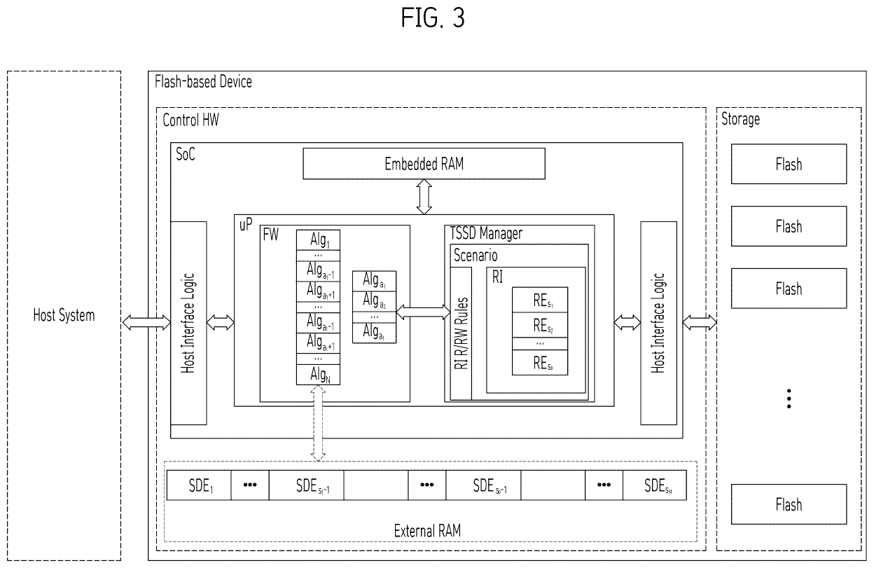

FIG. 3 is a diagram illustrating a logical structure of the flash-based device 10 and firmware with a target set of system data manager (hereinafter, referred to as TSSD manager) in accordance with an embodiment of the present disclosure.

Referring to FIGS. 1 and 3, the TSSD manager is in communication with components within the flash-based device 10. In general, the TSSD manager provides for computer simulation utilizing a computer program that models the behavior of a physical system, i.e., the flash-based device 10, over time. Program variables or state variables represent the current or initial state of the physical system at the beginning of the simulation. A simulation program in general modifies the state variables to predict the evolution of the physical system over time. In one embodiment of the present disclosure, a simulation entity is the program code of a mathematical algorithm representing the functions of an object of interest, with the code being executed by a core simulator.

There are several attributes of the TSSD manager. In performance of a simulation, the simulation is preferably faster and less complex than an actual operation performed on a real semiconductor memory system. Regarding any simulated scalability, hardware/firmware component preferably may be added/removed or replaced with other version(s) without affecting the remaining simulated components. In this aspect, the simulation entities are independent of each other, permitting the simulation entities to interact with each other. This scalability permits the TSSD manager to support different products and test different versions of firmware algorithms accurately. Regarding configurability, the value(s) of any simulated hardware/firmware component parameter is changeable before running a simulation. This configurability permits storage drive tuning for specific requirements.

In the following descriptions, the operation of the TSSD manager serving as a software-based engine for simulating the actions of simulated components in the flash-based device 10 will be described in detail. The operation reflects operations of the simulated components of real devices such as the flash-based device 10 involved in the simulation. Since the simulation entities simulate performance related to behavior for a particular component, descriptions of the functions of flash-based device 10 and their constituent components are provided below with an understanding that the simulation entities evaluate processes which may impact performance characteristics of those simulated components.

The flash-based device 10 may be implemented with any of various types of storage devices such as a solid-state drive (SSD) and a memory card. In various embodiments, in the flash-based device 10, flash-based device 10 may be one of various components in an electronic device such as, for example, a computer, an ultra-mobile personal computer (PC) (UMPC), a workstation, a net-book computer, a personal digital assistant (PDA), a portable computer, a web tablet PC, a wireless phone, a mobile phone, a smart phone, an e-book reader, a portable multimedia player (PMP), a portable game device, a navigation device, a black box, a digital camera, a digital multimedia broadcasting (DMB) player, a 3-dimensional television, a smart television, a digital audio recorder, a digital audio player, a digital picture recorder, a digital picture player, a digital video recorder, a digital video player, a storage device of a data centre, a device capable of receiving and transmitting information in a wireless environment, a radio-frequency identification (RFID) device, as well as one of various electronic devices of a home network, one of various electronic devices of a computer network, one of electronic devices of a telematics network, and/or one of various components of a computing system.

Referring to FIG. 1, in the simulations of flash-based device 10, the flash-based device 10 may include a memory controller 100 being simulated and a semiconductor memory device 200 being simulated. The memory controller 100 may control overall operations of the semiconductor memory device 200.

In the simulations, the semiconductor memory device 200 may perform one or more erase, program, and read operations under the control of the memory controller 100. The semiconductor memory device 200 may receive through input/output lines a command CMD, an address ADDR, and data DATA. The semiconductor memory device 200 may receive power PWR through a power line and a control signal CTRL through a control line. The control signal CTRL may include for example a command latch enable signal, an address latch enable signal, a chip enable signal, a write enable signal, a read enable signal, as well as other operational signals depending on design and configuration of the flash-based device 10. In the simulations, the memory controller 100 and the semiconductor memory device 200 may be a single semiconductor device such as a solid-state drive (SSD). The SSD may include a storage device for storing data therein. When the semiconductor flash-based device 10 is used in or modelled as an SSD, operation speed of a host device (e.g., host device 5 of FIG. 1) coupled to the flash-based device 10 may improve.

The memory controller 100 and the semiconductor memory device 200 in the simulations may be a single semiconductor device such as a memory card. For example, the memory controller 100 and the semiconductor memory device 200 may be a personal computer (PC) card of personal computer memory card international association (PCMCIA), a compact flash (CF) card, a smart media (SM) card, a memory stick, a multimedia card (MMC), a reduced-size multimedia card (RS-MMC), a micro-size version of MMC (MMCmicro), a secure digital (SD) card, a mini secure digital (miniSD) card, a micro secure digital (microSD) card, a secure digital high capacity (SDHC), and/or a universal flash storage (UFS).

Referring to back to FIG. 1, in the simulations, memory device 200 may store data to be accessed by a host device. The memory device 200 may be a volatile memory device such as, for example, a dynamic random-access memory (DRAM) and/or a static random-access memory (SRAM) or a non-volatile memory device such as, for example, a read only memory (ROM), a mask ROM (MROM), a programmable ROM (PROM), an erasable programmable ROM (EPROM), an electrically erasable programmable ROM (EEPROM), a ferroelectric random-access memory (FRAM), a phase change RAM (PRAM), a magneto-resistive RAM (MRAM), and/or a resistive RAM (RRAM).

The controller 100 in the simulations may control storage of data in the memory device 200. For example, the controller 100 may control the memory device 200 in response to a request from the host device. The controller 100 may provide data read from the memory device 200 to the host device and may store data provided from the host device into the memory device 200.

The controller 100 in the simulations may include a storage 110, a control component 120 which may be implemented as a processor such as, for example, a central processing unit (CPU), an error correction code (ECC) component 130, a host interface (I/F) 140 and a memory interface (I/F) 150, which are coupled through a bus 160.

The storage 110 in the simulations may serve as a working memory of the flash-based device 10 and the controller 100, and storage 110 may store data for driving the flash-based device 10 and the controller 100. When the controller 100 controls operations of the memory device 200, the storage 110 may store data used by the controller 100 and the memory device 200 for such operations as read, write, program and erase operations.

The storage 110 in the simulations may be a volatile memory such as a static random-access memory (SRAM) or a dynamic random-access memory (DRAM). As described above, the storage 110 may store data used by the host device in the memory device 200 for the read and write operations. To store the data, the storage 110 may include a program memory, a data memory, a write buffer, a read buffer, a map buffer, and the like.

The control component 120 in the simulations may control general operations of the flash-based device 10, and a write operation or a read operation for the memory device 200 in response to a write request or a read request from the host device. The control component 120 may drive firmware or other program instructions, which can be referred to as a flash translation layer (FTL), to control operations of the flash-based device 10. For example, the FTL may perform operations such as logical-to-physical (L2P) mapping, wear leveling, garbage collection, and/or bad block handling. The L2P mapping is known as logical block addressing (LBA).

The ECC component 130 in the simulations may detect and correct errors in the data read from the memory device 200 during a read operation. In one embodiment, the ECC component 130 may not correct error bits when the number of the error bits is greater than or equal to a threshold number of correctable error bits, but instead may output an error correction fail signal indicating failure in correcting the error bits.

The ECC component 130 in the simulations may perform an error correction operation based on a coded modulation such as, for example, a low density parity check (LDPC) code, a Bose-Chaudhuri-Hocquenghem (BCH) code, a turbo code, a turbo product code (TPC), a Reed-Solomon (RS) code, a convolution code, a recursive systematic code (RSC), a trellis-coded modulation (TCM), or a Block coded modulation (BCM). However, error correction is not limited to these techniques. As such, the ECC component 130 may include any and all circuits, systems or devices suitable for error correction operation.

The host interface 140 in the simulations may communicate with the host device through one or more of various communication standards or interfaces such as, for example, a universal serial bus (USB), a multi-media card (MMC), a peripheral component interconnect express (PCI-e or PCIe), a small computer system interface (SCSI), a serial-attached SCSI (SAS), a serial advanced technology attachment (SATA), a parallel advanced technology attachment (PATA), an enhanced small disk interface (ESDI), and an integrated drive electronics (IDE).

The memory interface 150 in the simulations may provide an interface between the controller 100 and the memory device 200 to allow the controller 100 to control the memory device 200 in response to a request from the host device. The memory interface 150 may generate control signals for the memory device 200 and process data under the control of the control component 120. In one embodiment where the memory device 200 is a flash memory such as a NAND flash memory, the memory interface 150 may generate control signals for the memory and process data under the control of the control component 120.

The memory device 200 as shown, for example, in FIG. 2 may in the simulations comprise a memory cell array 210, a control circuit 220, a voltage generation circuit 230, a row decoder 240, a page buffer array 250 which may be in the form of an array of page buffers, a column decoder 260, and an input and output (input/output) circuit 270. The memory cell array 210 may include a plurality of memory blocks 211 which may store data. The voltage generation circuit 230, the row decoder 240, the page buffer array 250, the column decoder 260 and the input/output circuit 270 may form a peripheral circuit for the memory cell array 210. The peripheral circuit may perform program, read, or erase operations of the memory cell array 210. The control circuit 220 may control the peripheral circuit.

The voltage generation circuit 230 in the simulations may generate operational voltages of various levels. For example, in an erase operation, the voltage generation circuit 230 may generate operational voltages of various levels such as an erase voltage and a pass voltage.

The row decoder 240 in the simulations may be in electrical communication with the voltage generation circuit 230, and the plurality of memory blocks 211. The row decoder 240 may select at least one memory block among the plurality of memory blocks 211 in response to a row address generated by the control circuit 220, and transmit operation voltages supplied from the voltage generation circuit 230 to the selected memory blocks.

The page buffer array 250 in the simulations may be coupled with the memory cell array 210 through bit lines BL (shown in FIG. 2). The page buffer array 250 may precharge the bit lines BL with a positive voltage, transmit data to and receive data from, a selected memory block in program and read operations, or temporarily store transmitted data in response to page buffer control signal(s) generated by the control circuit 220.

The column decoder 260 in the simulations may transmit data to and receive data from the page buffer array 250 or may transmit and receive data to and from the input/output circuit 270.

The input/output circuit 270 in the simulations may transmit to the control circuit 220 a command and an address, received from an external device (e.g., the memory controller 100 of FIG. 1), transmit data from the external device to the column decoder 260, or output data from the column decoder 260 to the external device through the input/output circuit 270.

The control circuit 220 in the simulations may control the peripheral circuit in response to the command and the address.

For example, the memory block of FIG. 2 may be any of the memory blocks 211 of the memory cell array 210 shown in FIG. 1.

Referring to FIG. 2, the memory block 211 in the simulations may include a plurality of word lines WL0 to WLn−1, a drain select line DSL, and a source select line SSL coupled to the row decoder 240. These lines may be arranged in parallel, with the plurality of word lines between the DSL and SSL.

The memory block 211 in the simulations may further include a plurality of cell strings 221 respectively coupled to bit lines BL0 to BLm−1. The cell string of each column may include one or more drain selection transistors DST and one or more source selection transistors SST. In the illustrated embodiment, each cell string has one DST and one SST. In a cell string, a plurality of memory cells or memory cell transistors MC0 to MCn−1 may be serially coupled between the selection transistors DST and SST. Each of the memory cells may be formed as a multiple level cell. For example, each of the memory cells may be formed as a single level cell (SLC) storing 1 bit of data. Each of the memory cells may be formed as a multi-level cell (MLC) storing 2 bits of data. Each of the memory cells may be formed as a triple-level cell (TLC) storing 3 bits of data. Each of the memory cells may be formed as a quadruple-level cell (QLC) storing 4 bits of data.

The source of the SST in each cell string in the simulations may be coupled to a common source line CSL, and the drain of each DST may be coupled to the corresponding bit line. Gates of the SSTs in the cell strings may be coupled to the SSL, and gates of the DSTs in the cell strings may be coupled to the DSL. Gates of the memory cells across the cell strings may be coupled to respective word lines. That is, the gates of memory cells MC0 are coupled to corresponding word line WL0, the gates of memory cells MC1 are coupled to corresponding word line WL1, etc. The group of memory cells coupled to a particular word line may be referred to as a physical page. Therefore, the number of physical pages in the memory block 211 may correspond to the number of word lines.

The page buffer array array 250 in the simulations may include a plurality of page buffers 251 that are coupled to the bit lines BL0 to BLm−1. The page buffers 251 may operate in response to page buffer control signals. For example, the page buffers 251 may temporarily store data received through the bit lines BL0 to BLm−1 or sense voltages or currents of the bit lines during a read or verify operation.

In various embodiments of the present disclosure, the memory blocks 211 in the simulations may be a NAND-type flash memory cell. However, the memory blocks 211 are not limited to such cell type, but may include NOR-type flash memory cell(s). Memory cell array 210 may be implemented as a hybrid flash memory in which two or more types of memory cells are combined, or one-NAND flash memory in which a controller is embedded inside a memory chip.

Referring to FIGS. 1 and 2, the memory device 200 in the simulations may include a plurality of memory cells (e.g., NAND flash memory cells). The memory cells are arranged in an array of rows and columns as shown in FIG. 2. The cells in each row are connected to a word line (e.g., WL0), while the cells in each column are coupled to a bit line (e.g., BL0). These word and bit lines are used for read and write operations. During a write operation in the simulations, the data to be written (‘1’ or ‘0’) is provided at the bit line while the word line is asserted. During a read operation in the simulations, the word line is again asserted, and the threshold voltage of each cell can then be acquired from the bit line. Multiple pages may share the memory cells that belong to (i.e., are coupled to) the same word line. When the memory cells are implemented with MLCs, the multiple pages include a most significant bit (MSB) page and a least significant bit (LSB) page. When the memory cells in the simulations are implemented with TLCs, the multiple pages include an MSB page, a center significant bit (CSB) page and an LSB page. When the memory cells in the simulations are implemented with QLCs, the multiple pages include an MSB page, a center most significant bit (CMSB) page, a center least significant bit (CLSB) page and an LSB page. The memory cells may be simulated for example using a coding scheme (e.g., Gray coding) in order to increase the capacity of the flash-based device 10 such as SSD.

FIG. 3 shows a different view of the flash-based device 10 from FIG. 1. Referring to FIG. 3, the flash-based storage device 10 should provide a host with a standard block interface for raw flash chip(s) inside the storage. Internally, the flash-based device 10 consists of multiple flash chips, one or more microprocessors, a certain amount of volatile embedded and/or external RAM memory and firmware FW, which usually runs on the microprocessor.

There may be configurations for the flash-based storage device 10. The configurations may use, as external RAM resources, a part of RAM resources of the host. The embodiments of the present disclosure are not limited to an exact location of the external RAM resources.

In the flash-based storage device 10, the flash translation layer FTL is a part of firmware FW and responsible for the address translation between the logical addresses and the physical addresses of the flash. For that purpose, the flash translation layer FTL manages the logical-to-physical (L2P) address mapping table, in which the index corresponds to a specific logical address and the entry value of the index specifies a physical address where data associated with the specific logical address is stored. The size of L2P table directly depends on the target capacity of the storage or a drive (e.g., under 1 GB of L2P table per 1 TB of storage capacity). A solid-state drive (SSD) with high throughput and/or QoS requirements may require a large amount of external RAM for the L2P table.

In addition, when a number of free pages is insufficient for write operations, the garbage collection is enabled by the firmware FW. The garbage collection is the process that makes a free region available by selecting the victim super block, moving the garbage-collected data from valid pages of the victim super block to a target super block and erasing the physical blocks from the victim super block.

To meet performance requirements, the garbage collection trigger and throttling algorithm is implemented in the flash translation layer FTL. The main idea of the garbage collection trigger and throttling algorithm is to divide the garbage collection work into small portions to find a balance between the host write operation and the garbage collection based on the estimated write amplification factor (WAF).

The behavior of the garbage collection trigger and throttling algorithm directly depends on many factors, such as algorithm implementation and parameters, target workload, etc. An example of a target workload is random read operations and random write operations with the same command size, the random read and write operations being mixed with a particular ratio thereof. In addition, customers' requirements for endurance/performance/reliability include various NAND conditions (e.g., cycle count, temperature, retention, etc.). The customers' requirements mainly relate to a steady state requiring a target precondition. An example of a target precondition is a predetermined number of random write operations performed on a target flash or a target drive in response to commands with a predefined and fixed size. The steady state may take a significant amount of time to achieve. Considering the complexity of the garbage collection trigger and throttling algorithm, many possibilities of parameters tuning and various target NAND states and drive verification against customer requirements is a well-known big time-consuming issue.

Besides experiments with real drives, there are many different techniques used to simplify the drive testing such as follows.

SSD characterization is the process designed to verify customer endurance/performance/reliability requirements in a near End-of-Life (EOL) state. A commonly used method to quickly reach the EOL state is using short stroke firmware FW, which reduces capacity and number of super blocks. However, this is not a very reliable verification method because scaling the drive to a reduced capacity requires maintaining and verifying many related firmware parameters. If the scaling parameters are not performed properly, the error will not be easy to find. Scaling is even more challenging when customer requirements specify a variety of target workloads.

The firmware simulator performs simulation of system on chip (SoC) and NAND components for metrics covered by a firmware test. The simulator provides a wide range of features that are very efficient for firmware development, unit and white box testing, etc. However, considering the huge number of SoC units for simulation, the simulator does not provide simulation speed suitable for reaching of a target steady state in reasonable time.

Another firmware simulator performs simulation of only critical SoC and/or firmware units for predefined target metrics. Reducing the number of SoC and/or firmware units to be simulated allows reducing the simulation time compared to the previous firmware simulator. However, considering the complexity of modern SSD firmware algorithms, it is hard to omit the preconditioning to measure some target metrics via behavioral models. For example, to measure write QoS during random write workload, a behavioral model should provide the realistic distribution of garbage collection victim blocks' validity, which affects the behavior of garbage collection trigger and throttling algorithm, and the target metric as a result. Therefore, such behavioral model should support L2P table simulation with appropriate preconditioning to be executed before measuring the write QoS.

Disclosed hereinafter is a solution for generating the steady state without process of executing a target precondition. The solution allows initializing the required firmware metadata with the values representing the target drive after the process of executing the target precondition. In addition, if a target metric is agnostic to host data, for example, if the target metric uses the same data pattern for any logical address, the solution allows removing the L2P table storing a target workload or any other firmware metadata affected by the target workload. The solution can be applied to firmware simulations and can be implemented in a real flash or drive to quickly reach the steady state and reduce the use of external RAM resources. Here, a target metric may be any of the requirements for the flash-based device 10, such as QoS, throughput, power consumption, data reliability, etc.

### Outline of Embodiment

Considering that both the firmware of the flash-based device 10 and firmware simulator should have implemented an algorithm capable of affecting the target metric for measurement, the firmware FW will be used for any type of firmware FW for further simplification.

To provide the required functionality of the flash-based device 10, such as converting host requests into internal flash operations or executing internal operations such as garbage collection, the firmware FW must generate some specific internal data, which is defined as system data SD in this disclosure. For example, the system data SD may be a set of counters such as erase counter, read counter, etc. to control the physical states of the flashes during the lifetime of the flash-based device 10, L2P tables for managing the physical access to data stored in the flashes, etc. The system data SD can be represented as a system data entity SDE, and an each of the system data entities SDEs is used by the firmware FW for a specific required function. Not all system data entities SDEs are used by the firmware FW during execution of a specific workload. Without limiting generality, one or more system data entities SDEs affected by target workload and/or target precondition are defined as a target set of system data TSSD in this disclosure. For example, if the workload is a sequential write workload, the firmware FW does not need to manage the read counters for counting read accesses because there are no host or internal reads at all. Therefore, the sequential write workload does not affect the read counters as the system data entities SDEs. For example, if the workload is a random read workload from the host, the read counters are frequently used for the random read workload. Therefore, the random read workload affects the read counters as the system data entities SDEs due to many read operations of the random read workload. That is, the read counters as the system data entities SDEs are the target set of system data TSSD for the target random read workload but the read counters are not the target set of system data TSSD for the target sequential write workload.

The main goal of the flash-based device 10 is to provide, in response to a request and a logical address from the host, the same data as previously written therein. However, due to NAND nature and customer needs, there are many other requirements for the flash-based device 10, such as QoS, throughput, power consumption, data reliability, etc. Most of these metrics are agnostic to a data pattern and a physical address used during the measurements of these metrics. For example, the main contributors to an average host read latency under low queue-depth workload are device hardware overhead and NAND read overhead, which are the same for different data patterns and physical addresses in case of SLC NAND usage. However, for more precise metrics such as read latency distribution, additional factors should be considered such as the ratios of fully and partially written super blocks on a precondition because the partially written super block is less reliable and therefore the flash-based device 10 needs more time to handle NAND read errors in case of an error handling. However, the metric such as read latency distribution is still agnostic to the data pattern and physical address if the access ratios of fully and partially written super blocks are the same. The example described later shows that, to measure the target metric, it is sufficient to replace the entire L2P table with a simple unit that redirects host read requests to random super blocks with respect to the corresponding ratios of fully and partially written super blocks. The example also demonstrates the idea of the present disclosure.

According to an embodiment of the present disclosure, the TSSD manager can be implemented as a part of the firmware FW and the TSSD manager may allow the firmware FW to access the target set of system data TSSD in response to read and/or write requests. The TSSD manager provides the function of initializing the target set of system data TSSD. The TSSD manager also provides the function of mimicking (i.e. imitating) access of the firmware FW to the target set of system data TSSD.

With the function of initializing the target set of system data TSSD and based on the target precondition and target workload parameters such as access type, command size, etc., the TSSD manager defines a scenario from a set of predefined scenarios SPS, which includes the target set of system data TSSD, i.e., the system data entity SDE affected by the target precondition and target workload. Here, a scenario in this disclosure means a workload under one or more particular NAND conditions. For example, the test on a flash or a drive is measuring read latency at end-of-life NAND state during 4 KB random read workload with a queue depth (QD) having a value of one (1), which means that the host provides a next command only after completion of processing a previous command, the size of 4 KB being aligned with the size of the L2P mapping unit. In this case, the scenario is formed by the following three (3) entities: the read latency, the end-of-life NAND state and the 4 KB random read workload with the QD having the value ‘1’. Such a scenario may be predefined according to the test item of interest.

With the function of initializing the target set of system data TSSD and based on the target precondition and target workload parameters, the TSSD manager also defines an access pattern for the target set of system data TSSD during the execution of the target workload.

With the function of initializing the target set of system data TSSD and based on the target precondition and target workload parameters, the TSSD manager also creates a reduced image RI of the target set of system data TSSD by replacing the target set of system data TSSD with one or more reduced entities REs.

Hereinafter, some concepts will be defined. In the example of the above discussed scenario of the workload of the 4 KB random read workload with the QD having the value ‘1’, in order to get reasonable results before execution of the read test, the flash or the drive should not be empty. Therefore, some information should be written into the drive. This operation of writing information into the drive is a precondition operation, which is to be performed before the read test. For example, the precondition is a sequential write workload on the flash or the drive where each 4 KB of data has the same data pattern such as all zeros or ones, a predefined random pattern, etc. The rest of precondition parameters such as a command size is out of focus of the example. During both the precondition operation (i.e., the operation of writing information into the drive) and the precondition workload (i.e., the sequential write workload on the drive), the L2P table is used by the firmware FW to process a host command. The L2P is updated by the firmware FW during the precondition operation and the precondition workload and is read by the firmware FW during the target workload (i.e., the workload of the 4 KB random read workload with the QD having the value ‘1’). Therefore, the L2P table can be defined as the target set of system data TSSD for the example. The data pattern of the precondition workload (i.e., the sequential write workload on the drive) allows that, after the precondition operation (i.e., the operation of writing information into the drive), entries of the L2P table with indices from zero (0) to a maximum number MAX_LBA of logical addresses, which is defined by the capacity of the flash or the drive, contain also a sequential pattern of physical addresses, which may start from zero (0) or a known initial physical address INIT_PA. In this case, the maximum number MAX_USED_PA of possible physical addresses is calculated by ‘INIT_PA+MAX_LBA’. Therefore, the whole L2P table after the precondition workload (i.e., the sequential write workload on the drive) can be represented just by two numbers INIT_PA and MAX_USED_PA respectively representing the initial physical address and the maximum number of possible physical addresses. These two numbers INIT_PA and MAX_USED_PA form a reduced entity RE of the L2P table as the target set of system data TSSD for the precondition workload (i.e., the sequential write workload on the drive) and the precondition operation (i.e., the operation of writing information into the drive).

Although the above discussed example shows a single reduced entity RE (i.e., the set of initial physical address INIT_PA and maximum number MAX_USED_PA of possible physical addresses) representing the target set of system data TSSD (i.e., the L2P table), plural reduced entities REs may represent a target set of system data TSSD. A set of one or more reduced entities REs representing the target set of system data TSSD may be the reduced image RI of the target set of system data TSSD. The reduced image RI may depend on the selected scenario.

With the function of initializing the target set of system data TSSD and based on the target precondition and target workload parameters, the TSSD manager also properly initializes the reduced image RI of the target set of system data TSSD based on precondition workload parameters and firmware parameters (e.g., logical capacity, number of super blocks, garbage collection trigger and throttling thresholds, etc.). This proper initialization of the reduced image RI of the target set of system data TSSD allows execution of the target workload without the preconditioning.

In the above discussed example of the reduced image RI (i.e., the set of initial physical address INIT_PA and maximum number MAX_USED_PA of possible physical addresses) of the target set of system data TSSD (i.e., the L2P table), the TSSD manager properly initializes the initial physical address INIT_PA depending on the firmware parameters, for example, a number of physical blocks initially to be allocated for an internal need of the firmware EW, a numeration scheme of physical blocks and so forth. Also, the TSSD manager properly initializes the maximum number MAX_USED_PA of possible physical addresses to have the value ‘MAX_USED_PA=INIT_PA+MAX_LBA’ depending on the precondition workload that uses all capacity of the flash or the drive. When the precondition workload utilizes the LBAs of small range, maximum number MAX_USED_PA of possible physical addresses may be adjusted accordingly.

In the above discussed scenario of the workload of the 4 KB random read workload with the QD having the value ‘1’, the firmware FW should read a physical address stored in the L2P table based on the LBA provided from the host. However, considering randomness of the random read workload, a physical address can be randomly generated within the range from initial physical address INIT_PA to maximum number MAX_USED_PA of possible physical addresses. Therefore, a random generator and the reduced image RI (i.e., the set of initial physical address INIT_PA and maximum number MAX_USED_PA of possible physical addresses) allows removal of the L2P table stored in an operating memory such as DRAM for the scenario.

With the function of mimicking access of the firmware FW to the target set of system data TSSD during the execution of the target workload, the TSSD manager processes requests from the firmware FW to the target set of system data TSSD using the appropriate reduced image RI of the target set of system data TSSD and the TSSD manager updates, if needed, the reduced image RI of the target set of system data TSSD according to the scenario. If there is no appropriate scenario in the set of predefined scenarios SPS for the target precondition and target workload, the target set of system data TSSD should be disabled.

With the function of mimicking access of the firmware FW to the target set of system data TSSD during the execution of the target workload, the TSSD manager replaces the target set of system data TSSD with the reduced image RI of the target set of system data TSSD, which allows reducing the usage of external RAM resources.

### Details of Embodiment

Referring to FIG. 3, in order to satisfy the requirements for metrics that is agnostic to data pattern, the flash-based device 10 and the firmware FW have corresponding firmware algorithms with the required system data entity SDE. Note that, under the algorithm, a firmware function or even a part of the firmware function is further considered. A total N number of firmware algorithms Alg with indices {1, . . . , N} operate with a set of a M number of system data entities SDE with indices {1, . . . , S_{M}}.

The firmware FW has a predefined path for an external or internal command of a specific type and triggers a predefined subset of firmware algorithms with indices {a₁, . . . , aₜ}, which will be as described later. In addition, the type of command defines an access pattern to a corresponding system data entity SDE by a triggered firmware algorithm from the subset of firmware algorithms with indices {a₁, . . . , aₜ}. The subset of firmware algorithms with indices {a₁, . . . , aₜ} involved while serving the command is not a constant and depends on NAND state conditions and/or a state of the system data entity SDE with indices {1, . . . , S_{M}}.

Selecting the subset of firmware algorithms with indices {a₁, . . . , aₜ} is required for the TSSD manager and the reduced image RI of the target set of system data TSSD for a target workload.

The subset of firmware algorithms with indices {a₁, . . . , aₜ} is selected according to a target test case represented by the parameters of target workload, the target metric and the NAND state conditions.

As to the parameters of target workload, as an example is two (2) intensive read workloads as the target workloads: a short read workload of performing read operations for up to 1 hour and a long read workload of performing read operations for several days. In this example, the rest parameters may remain the same between the short and long read workloads. Execution of the short read workload does not trigger the read disturb prevention algorithms due to a small number of read operations per physical block. However, execution of the long read workload triggers the read disturb prevention algorithms during the long period of the read operations. The read disturb prevention algorithms are selected according to the short and long read workloads as the target workloads.

As to the target metric, the read only workload has a low queue depth. When the target metric is latency, the read defense algorithms should be considered. When the target metric is throughput, the read defense algorithms can be omitted. Triggering the read defense algorithms is an event with a small probability and therefore the triggering does not affect the read operation on average. The read defense algorithms are selected according to the type of the target metric.

As to the NAND state conditions, triggering data relocation algorithms due to the program/read/erase failure is more relevant for the end-of-life NAND state between the start-of-life and end-of-life NAND states. In addition, triggering the read defense algorithms has higher probability at the end-of-life NAND state. The data relocation algorithms and the read defense algorithms are selected according to the NAND state conditions.

The parameters of target workload are to limit a number of triggered firmware algorithms by a predefined type of host command. Information about the test duration helps to exclude firmware algorithms that can be triggered under certain conditions, e.g., after reaching a certain threshold.

The target metric provides information to exclude firmware algorithms that do not affect the target metric.

The NAND state condition or the target precondition defines NAND error frequencies that enable predefined error handling firmware algorithms.

For fixed NAND conditions and based on the target metric measured under the target workload, the firmware algorithms with indices {i₁, . . . , iₖ} participate in internal and external command processing. Implementation of the firmware algorithms with indices {i₁, . . . , iₖ} straightforwardly specifies a subset of system data entities SDEs with indices {j₁, . . . , jₗ} used by the firmware algorithms with indices {i₁, . . . , iₖ} during the execution of the target workload. It may not be needed that a subset of the firmware algorithms with indices {i₁, . . . , iₖ} and the specified subset of system data entities SDEs with indices {j₁, . . . , jₗ} have the same size.

The set of firmware algorithms with indices {i₁, . . . , iₖ} depends on the firmware architecture, the NAND architecture and the target metric. An example of the firmware algorithms with indices {i₁, . . . , iₖ} may be the read disturb prevention algorithms, the read defense algorithms and the data relocation algorithms, which are an example of the selected subset of firmware algorithms with indices {a₁, . . . , aₜ} as discussed above.

Then, the specified subset of system data entities SDEs with indices {j₁, . . . , jₗ} is replaced with a reduced entity RE, which requires less RAM compared to the initial system data entity SDE. The reduced entity RE can be represented as one or combination of an analytical model, a random number generator with a specific distribution, a simple logic, a constant value, a counter, etc.

The possibility of replacing the system data entity SDE from the specified subset of system data entities SDEs with indices {j₁, . . . , jₗ} with the reduced entity RE is hardly dependent on the target metric. However, the system data entity SDE from the specified subset of system data entities SDEs with indices {j₁, . . . , jₗ} can be replaced with the reduced entity RE if replacing the system data entity SDE from the specified subset of system data entities SDEs with indices {j₁, . . . , jₗ} with the reduced entity RE does not affect the target metric in case of read and/or write access from any firmware algorithm with indices {i₁, . . . , iₖ}. The reduced entity RE should be added to the reduced image RI of the target set of system data TSSD for the target workload. If there is no suitable reduced entity RE for the target metric, the initial system data entity SDE itself from the specified subset of system data entities SDEs with indices {j₁, . . . , jₗ} should be added to the firmware FW.

While replacing the system data entity SDE from the specified subset of system data entities SDEs with indices {j₁, . . . , jₗ} with the reduced entity RE, the system data entities SDEs with indices {s₁, . . . , sₚ} among the specified subset of system data entities SDEs with indices {j₁, . . . , jₗ} (i.e., {s₁, . . . , sₚ}⊂{j₁, . . . , jₗ}) have been replaced with corresponding reduced entities REs, the reduced entities REs form the reduced image RI of the target set of system data TSSD and the replaced system data entities SDEs with indices {s₁, . . . , sₚ} form the target set of system data TSSD for the target workload.

The target set of system data TSSD for the target workload, i.e., the subset of system data entities SDEs with indices {s₁, . . . , sₚ} replaced with the reduced image RI of the target set of system data TSSD exactly defines the subset of firmware algorithms with indices {a₁, . . . , aₜ} from among the selected firmware algorithms with indices {i₁, . . . , iₖ} (i.e., {a₁, . . . , aₜ} {i₁, . . . , iₖ}). The subset of firmware algorithms with indices {a₁, . . . , aₜ} manages the target set of system data TSSD for the target workload, i.e., the subset of replaced system data entities SDEs with indices {s₁, . . . , sₚ}. Thus, during the execution of the target workload, the firmware FW should redirect a read/write request from the subset of the firmware algorithms with indices {a₁, . . . , aₜ} to the TSSD manager, which manages the corresponding reduced image RI of the target set of system data TSSD for the target workload.

In the example of the above discussed scenario of the workload of the 4 KB random read workload with the queue depth (QD) having the value ‘1’, a firmware algorithm may be considered as responsible for converting a logical address to a physical address through the L2P table, which is the target set of system data TSSD represented by the reduced entity RE (i.e., the set of initial physical address INIT_PA and maximum number MAX_USED_PA of possible physical addresses).

The request from the subset of the firmware algorithms with indices {a₁, . . . , aₜ} to the TSSD manager includes an information format of {ALG_ID, RQ_TYPE, SDE_ID, VALUE}.

In the above format of request, ALG_ID is an identifier of a firmware algorithm from the subset of the firmware algorithms with indices {a₁, . . . , aₜ}. The selected firmware algorithm requests access to a system data entity SDE from the subset of replaced system data entities SDEs with indices {s₁, . . . , sₚ}, i.e., the target set of system data

TSSD for the target workload.

In the above format of request, RQ_TYPE defines a type (i.e., read or write) of the request to the system data entity SDE from the subset of replaced system data entities SDEs with indices {s₁, . . . , sₚ}, i.e., the target set of system data TSSD for the target workload.

In the above format of request, SDE_ID is an identifier of the system data entity SDE from the subset of replaced system data entities SDEs with indices {s₁, . . . , sₚ}, i.e., the target set of system data TSSD for the target workload. The selected system data entity SDE is to be accessed by the firmware algorithm from the subset of the firmware algorithms with indices {a₁, . . . , aₜ}. The selected system data entity SDE is to be used by the TSSD manager to provide access to the corresponding reduced entity RE.

In the above format of request, VALUE is a new value for updating the selected system data entity SDE.

Therefore, for each reduced entity RE from the reduced image RI of the target set of system data TSSD, for each firmware algorithm from the subset of the firmware algorithms with indices {a₁, . . . , aₜ} and for each type of the request from the firmware algorithm to the system data entity SDE from the subset of replaced system data entities SDEs with indices {s₁, . . . , sₚ}, i.e., the target set of system data TSSD for the target workload, the TSSD manager should properly process the request redirected from the firmware FW. The logic of the processing of the TSSD manager will be called a rule. A set of rules and the corresponding reduced image RI of the target set of system data TSSD form a scenario of the TSSD manager for the target test case represented by the target precondition, the target workload, the target metric, etc.

The implementation of each rule strongly depends on the reduced entity RE. For example, if the reduced entity RE is represented as a simple constant, then the TSSD manager will return the constant value to the firmware FW in case of a read request redirected from the firmware FW and will do nothing in case of a write request redirected from the firmware FW. For example, if the reduced entity RE is represented as a random number generator with a specific distribution, then the TSSD manager should generate a random number through the random number generator and return the generated random number to the firmware FW in case of a read request redirected from the firmware FW. For example, if the reduced entity RE is represented as a random number generator with a specific distribution, then the TSSD manager properly updates, in case of a write request redirected from the firmware FW, the distribution of the random number generator based on the value of the field VALUE from the write request.

Before the target workload is executed, with the function of initializing the target set of system data TSSD, the TSSD manager should properly initialize the reduced image RI of the target set of system data TSSD according to the firmware parameters and the precondition parameters. Therefore, the firmware FW must provide access to its parameters from the TSSD manager. The initialization allows skipping the preconditioning and can be done using various sources such as required statistics collected on the real drive, an analytical model, statistics collected during third-party simulation, etc.

After initialization, the firmware FW with the TSSD manager is ready to execute the target workload and measure the target metric in a product requirements document (e.g., a drive characteristic such as a throughput). With the function of mimicking access of the firmware FW to the target set of system data TSSD during the execution of the target workload, the TSSD manager processes requests from the firmware FW to target set of system data TSSD using the appropriate reduced image RI of the target set of system data TSSD and the TSSD manager updates, if needed, the reduced image RI of the target set of system data TSSD according to the scenario. Considering the TSSD manager's extensive knowledge of the target workload parameters, it is possible to extend the TSSD manager scenario with the workload generator, e.g., to simplify the hardware environment used for next-generation NAND testing and data collection.

### Example of Function of Initializing Target Set of System Data TSSD

To show the benefit of the above example, the following input conditions are utilized.

Target precondition: a predetermined number of times of rewriting the entire capacity of the target drive by a random workload in response to commands with predefined and fixed size.

Target workload: random read operations and write operations with the same command size are mixed with a particular ratio thereof.

Target metric: a drive throughput and host commands latency distribution in a steady state are among various requirements for the flash-based device 10, such as QoS, throughput, power consumption, data reliability, etc.

To simplify the example, the read and write command sizes, a L2P mapping unit and a logical address size are aligned with NAND flash physical page size.

The following is suggested for illustrative and descriptive purposes. It is not intended to limit the embodiments of the present disclosure to a precise form. The embodiments of the present disclosure can be adjusted for other workloads with different access patterns (e.g., sequential read/write), different command sizes not aligned with the L2P mapping unit or the physical page size, the target metrics, etc.

According to the target precondition, the drive or the storage should be in a steady state, i.e., its parameters (e.g., the write amplification factor (WAF), the number of valid pages in the victim super block of the garbage collection, etc.) measured at different moments of time have the same values on average. Therefore, the behavior of the firmware algorithms (e.g., the garbage collection throttling) affected by the target parameters (e.g., the victim super block processing time by garbage collection, etc.) does not change significantly. Moreover, the target workload does not change the behavior of the firmware algorithms because the write commands have the same size used on the preconditioning and the read commands cannot be a cause of firmware internal write or logical address invalidation (except for some error handling cases that are out of the example). However, the drive parameters mentioned are not constant and minor changes in the target parameters can significantly affect the target metric, especially the distribution of the write commands. The target metric is not sensitive to a data pattern used during the execution of the target workload.

During the preconditioning and execution of the target workload, the drive firmware FW uses a L2P table and a physical-to-logical (P2L) table as the system data SD. The L2P table is to get a physical address for a read command and store a new physical address in case of a write operation requested by a host system or a write operation in the garbage collection. An index of the P2L table corresponds to a specific super block and an offset in the super block and the entry value therein specifies a logical address stored in the super block by the corresponding offset. The firmware FW uses the P2L table to quickly identify valid pages in the super block during the garbage collection.

Described below is the TSSD manager scenario that allows replacing the L2P and P2L tables with the reduced image RI (e.g., the set of initial physical address INIT_PA and maximum number MAX_USED_PA of possible physical addresses as the set of reduced entity RE) of the target set of system data TSSD (e.g., the L2P and P2L tables), the reduced image RI requiring significantly less memory and providing the same behavior of the firmware algorithm from the subset of the firmware algorithms with indices {a₁, . . . , aₜ} as in the initial drive from among the selected firmware algorithms with indices {i₁, . . . , iₖ} ({a₁, . . . , aₜ}⊂{i₁, . . . , iₖ}).

When an appropriate scenario for the precondition and the workload has already been implemented and stored in the set of predefined scenarios SPS, the TSSD manager should allocate space for validity vector VV and valid page count vector VPCV, which are initialized with zero. An entry index of the validity vector VV represents a super block used to store user data and the entry value of the validity vector VV represents a share of valid pages in the super block among all logical addresses. An entry index of the valid page count vector VPCV represents a super block used to store user data and the entry value of the valid page count vector VPCV represents the number of valid pages in the super block.

Both the validity vector VV and valid page count vector VPCV have the same size equal to a number of the super blocks allocated by the firmware FW to store user data (available from firmware configuration). Both the validity vector VV and valid page count vector VPCV form the reduced image RI of the target set of system data TSSD for the scenario. In the case that the target set of system data TSSD consists of two (2) target system data entities SDEs of L2P and P2L tables, both the L2P and P2L tables can be represented by validity vector VV and valid page count vector VPCV for the scenario. Therefore, the validity vector VV and valid page count vector VPCV may be the reduced entities REs of the target system data entities SDEs comprising the L2P and P2L tables. Both the validity vector VV and valid page count vector VPCV as the reduced entities REs may form one reduced image RI of the target set of system data TSSD for the scenario. One vector can be restored from the other. Therefore, in general, it is possible to use only one of them. However, the restoring operation requires a lot of floating-point operation, which can significantly affect the target metric.

The TSSD manager initializes the vectors, which can be done using the analytical approach described in the below section ANALYTICAL ESTIMATION OF STEADY-STATE DISTRIBUTION OF VALID PAGES VPS UNDER RANDOM WRITE WORKLOAD using the following firmware parameters: a total number of logical addresses, a number of super blocks allocated by the firmware FW to store user data (excluding super blocks allocated for firmware metadata, any open super block except for the garbage collection, super blocks that should always be empty according to garbage collection policy, etc.) and a number of pages for user data per super block (excluding pages that firmware FW may use for storing of its metadata, e.g. part of P2L, checksum parity, etc.).

After the initialization of the validity vector VV and valid page count vector VPCV, the state of validity vector VV and valid page count vector VPCV fully corresponds to the distribution of super blocks validity on the real drive after the precondition. During the execution of the target workload, the TSSD manager uses the validity vector VV and valid page count vector VPCV, i.e., the reduced image RI of the target set of system data TSSD, the reduced image RI being initialized, to serve the firmware request and update the reduced image RI of the target set of system data TSSD accordingly.

### Example of Function of Mimicking Access of Firmware FW to Target Set of System Data TSSD During Execution of Target Workload

### Host Write Processing

When processing a host write command, an ordinary firmware FW should replace the previous physical address corresponding to the logical address within the corresponding L2P entry with a new physical address by assigning, for the logical address, a super block and an offset on the assigned super block. This means that the stored data represented by the previous physical address becomes invalid and the number of valid pages in the assigned super block for the host data is increased by one. The invalidation of the stored data represented by the previous physical address may cause a decrease in the entries of valid page count vector VPCV for the super block indicated by the previous physical address. The increase in the number of valid pages in the assigned super block may cause an increase in the entries of valid page count vector VPCV for the assigned super block.

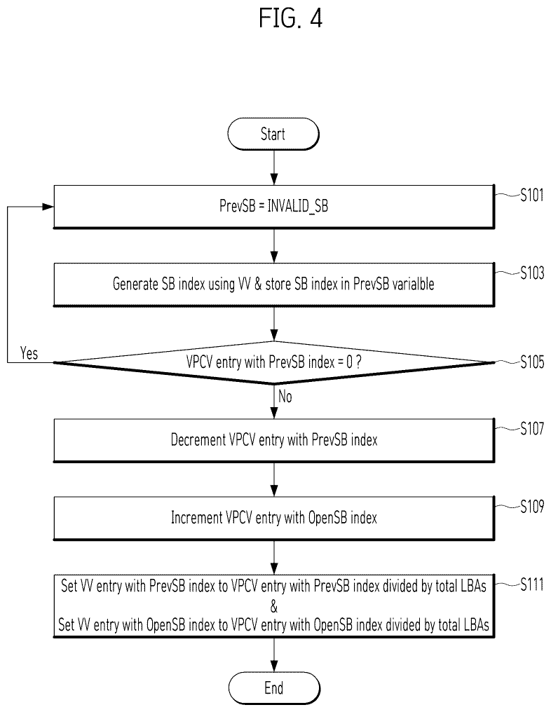

Based on the precondition and the used workload parameters, the total number of valid pages among all super blocks must be a constant and equal to the total number of logical addresses. Therefore, during the host write processing, the TSSD manager should decrease the entry indexes of the valid page count vector VPCV and increase the entry index of the valid page count vector VPCV corresponding to the assigned super block for the host data. All logical addresses are distributed among super blocks according to the current state of valid page count vector VPCV, which means that, when the host randomly generates a logical address for the current write command, the previous location corresponding to the logical address can be any super block with corresponding probability of the share of valid pages within the super block among all logical addresses. Thus, the TSSD manager can randomly select an entry of the valid page count vector VPCV for the decreasing based on the current state of validity vector VV as an input distribution for a random number generator. FIG. 4 shows the entire process of updating the reduced image RI of the target set of system data TSSD in the case of processing the host write request, where the index of the assigned super block for the host data is denoted as “OpenSB”.

FIG. 4 is a flowchart illustrating an operation of the host write processing in accordance with an embodiment of the present disclosure. FIG. 4 describes the process of updating an L2P entry, i.e., the process of invalidating a previous physical address corresponding to a LBA and assigning a new physical address for the assigned open super block SB. The process of FIG. 4 is performed by the firmware FW during processing of writing the host LBA.

At operation S101, a variable PrevSB may be initialized with a greater value INVALID_SB than a total number of SBs managed by the firmware FW.

At operation S103, the previous SB index corresponding to an input LBA may be generated using the current state of validity vector VV. The SB index generated may be stored as the variable PrevSB. All LBAs are distributed among the SBs according to the current state of valid page count vector VPCV. That is, when the host randomly generates an LBA for a current write command, a previous location corresponding to the LBA can be any SB with corresponding probability of the share of valid pages within the SB among all LBAs. Thus, the previous SB index corresponding to the input LBA may be generated using the current state of validity vector VV as an input distribution for a random number generator.

At operation S105, checked may be whether a SB, an index of which is equal to the value of variable PrevSB, has valid pages by checking whether a corresponding valid page count vector VPCV entry is not equal to zero (0). If the corresponding VPCV entry equals zero (0), i.e., if there are no valid pages in the corresponding SB, the process proceeds to the operation S101. If the corresponding VPCV entry is not zero (0), i.e., if there are one or more valid pages in the corresponding SB, the process proceeds to operation S107.

At the operation S107, decreased may be the VPCV entry, an index of which is equal to the value of the variable PrevSB. The operation S107 may be equivalent to invalidating the previous physical address corresponding to the input LBA.

At operation S109, increased may be the VPCV entry, the index of which is equal to the value of variable OpenSB. The operation S109 may be equivalent to assigning a new physical address for an open SB for the host write.

At operation S111, adjusted may be the corresponding VV entries according to the VPCV update by the operations S107 and S109. The operation S111 may keep the consistency of both tables of the VPCV and VV. Through the operation S111, set may be the VV entry with the PrevSB index to the VPCV entry with the PrevSB index, which is divided by the total number of LBAs. Also, through the operation S111, set may be the VV entry with the OpenSB index to the VPCV entry with the OpenSB index, which is divided by the total number of LBAS.

### Garbage Collection Read Processing

To execute the garbage collection read operation of reading the garbage-collected data from the victim super block, the firmware FW uses the L2P table and P2L table to identify victim pages storing the garbage-collected data within the victim super block. A set of logical addresses indicating data written to the victim super block by the corresponding offsets is known from the P2L table. If a logical address from the P2L table is the same as in the L2P table, the firmware FW marks the logical address as valid and invalid vice versa. Thus, after processing the P2L and L2P tables, the firmware FW has a map of the victim pages within the victim super block.

The target metric is sensitive to the number of garbage collection reads per victim super block, because, in case of the collision of host read/write with garbage collection read at a NAND level, this significantly affects a host command latency while the probability of such collision is directly depending on the number of garbage collection reads. Therefore, the firmware FW requests the TSSD manager to provide a similar map of the to-be-read victim pages within the victim super block. Based on the randomness of the workload and knowledge of the number of valid pages from valid page count vector VPCV for the victim super block of the current garbage collection, the TSSD manager can randomly distribute valid pages in the victim super block and restore the map of the to-be-read victim pages within the victim super block in consideration of the host and firmware data (e.g., XOR parity, P2L table, etc.) layout in a super block.

### Garbage Collection Write Processing

On the garbage collection write operation of writing the garbage-collected data from the victim super block into the target super block, the firmware FW knows the previous and target locations corresponding to the logical address because both the victim super block and target super block are assigned by the firmware FW according to its internal policies. Thus, the TSSD manager can directly update the reduced image RI of the target set of system data TSSD using the index of the victim super block (denoted as “PrevSB”) and the index of the target super block for garbage collection data (denoted as “OpenSB”) for processing the garbage collection write request.

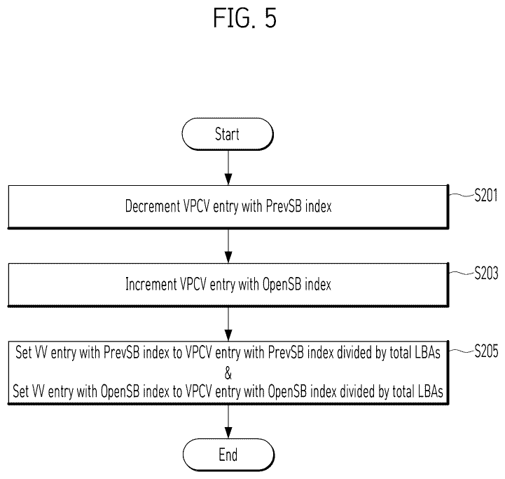

FIG. 5 is a flowchart illustrating an operation of the garbage collection write processing in accordance with an embodiment of the present disclosure. FIG. 5 shows the process of updating an L2P entry by the garbage collection, i.e., the process of invalidating a previous physical address corresponding to a LBA of the victim super block and assigning a new physical address for an open SB as the target super block. The process of FIG. 5 may be performed by the firmware FW during the process of writing the garbage collected data into the target super block. Both the victim SB index, which is stored as the variable PrevSB, and the target SB index, which is stored as the variable OpenSB, are assigned by the firmware FW according to its internal policies for the garbage collected data.

At operation S201, decreased may be the VPCV entry, an index of which is equal to the value of variable PrevSB. The operation S201 may be equivalent to invalidating the previous physical address for the victim super block corresponding to the LBA for the garbage collection.

At operation S203, increased may be the VPCV entry, the index of which is equal to the value of variable OpenSB variable. The operation S203 may be equivalent to assigning a new physical address for an open SB as the target super block for the garbage collection.

At operation S205, adjusted may be the corresponding VV entries according to the VPCV update by the operations S201 and S203. The operation S205 may keep the consistency of both tables of the VPCV and VV. Through the operation S205, set may be the WV entry with the PrevSB index to the VPCV entry with the PrevSB index, which is divided by the total number of LBAs. Also, through the operation S205, set may be the VV entry with the OpenSB index to the VPCV entry with the OpenSB index, which is divided by the total number of LBAs.

### Host Read Processing

On the host read request, the firmware FW should translate the logical address to the physical address. To process host read request without the L2P table, the TSSD manager should assign a super block and offset in the assigned super block. The target metric is not affected by the super block index to read if all super blocks have the same NAND conditions. To generate the super block index for subsequent operations for the host read processing, the TSSD manager uses the current state of validity vector VV because the probability of a logical address representing data stored in a super block is directly dependent on the share of valid pages within the super block among all logical addresses. Considering that the workload is random, the TSSD manager randomly generates the offset in the super block with respect to the host and firmware data layouts and the fully or partially written state of the super block, which are available from the firmware FW.

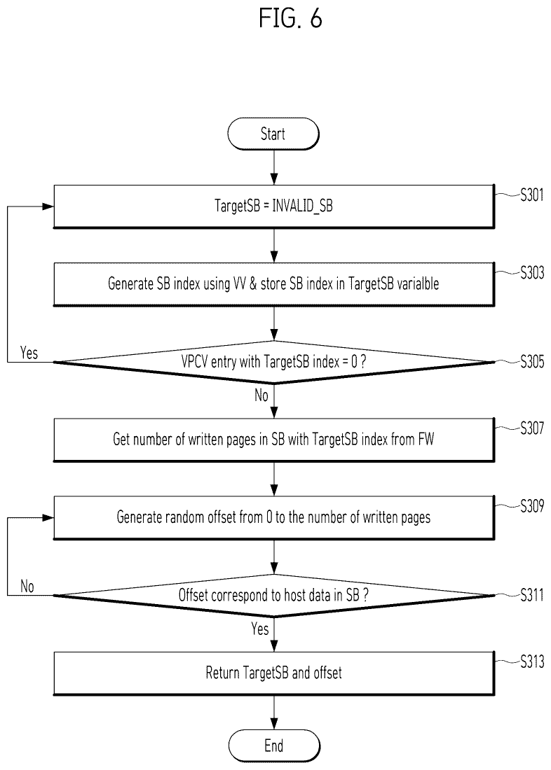

FIG. 6 is a flowchart illustrating an operation of the host read processing in accordance with an embodiment of the present disclosure. Considering that the workload is random, a physical address represented as an SB index and offset may be generated through the validity vector VV for an LBA of the to-be-read data. It is because the probability of an LBA for an SB is directly dependent on the share of valid pages within the SB among all LBAs.

At operation S301, a variable TargetSB may be initialized with a greater value INVALID_SB than the total number of SBS managed by the firmware FW.

At operation S303, all LBAs are distributed among the SBs according to the current state of valid page count vector VPCV. That is, when the host randomly generates an LBA for a current read command, a current location corresponding to the LBA can be any SB with corresponding probability of the share of valid pages within the SB among all LBAs. Thus, the current SB index corresponding to the input LBA may be generated using the current state of VV as an input distribution for a random number generator. The SB index generated may be stored as the variable TargetSB.

At operation S305, checked may be whether a SB, an index of which is equal to the value of variable TargetSB, has valid pages by checking whether a corresponding valid page count vector VPCV entry is not equal to zero (0). If the corresponding VPCV equals zero (0), i.e., if there are no valid pages in the corresponding SB, the process proceeds to the operation S301. If the corresponding VPCV entry is not zero (0), i.e., if there are one or more valid pages in the corresponding SB, the process proceeds to operation S307.

At the operation S307, obtained from the firmware FW may be the number of written pages in the SB with the TargetSB index. A SB can be at different states during a workload execution, e.g., fully or partially written if the SB is open for the host write or the garbage collection write. The firmware FW knows the state of the SB with the TargetSB index of the variable TargetSB and may provide the number of already written pages in the SB with the TargetSB index of the variable TargetSB.

At operation S309, generated may be a random offset within a range from zero (0) to the number of written pages. Considering that the workload is random and uniform by a LBA, the input LBA may correspond to an offset in the SB, the index of which is equal to the value of variable TargetSB. However, the offset should not exceed the number of written pages. So, the offset in the SB can be generated using a random uniform generator within the range.

At operation S311, checked may be whether the generated offset corresponds to host data in the SB, the index of which is equal to the value of variable TargetSB. The firmware FW may pre-define how to store host data as well as FW metadata within a SB. For example, a whole SB may be allocated for the host data. For example, predefined pages may be allocated for the FW metadata and remaining pages may be allocated for the host data within the SB. Therefore, verified should be whether the generated offset corresponds to the pages allocated for the host data within in the SB, the index of which is equal to the value of variable TargetSB. If the generated offset corresponds to the pages allocated for the host data, the process proceeds to operation S313. If the generated offset does not correspond to the pages allocated for the host data, the process proceeds to the operation S309.

At the operation S313, returned to the firmware FW may be the generated physical address represented as the TargetSB index and the offset for subsequent operations for the host read processing.

### Analytical Estimation of Steady-State Distribution of Valid Pages VPs Under Random Write Workload

Consider the problem of finding the distribution of valid pages VPs among super blocks in a steady state under the random write workload with 100% device range coverage.

Let each super block consist of n pages to store user data (that is, pages used for system data SD should not be considered) and there are m super blocks for user data (that is, super blocks used to store system data SD or super blocks allocated by the firmware FW for use in emergency cases should not be considered). Thus, the effective over-provisioning in this case is:

a: =P/U−1>0, where P=nm is the physical capacity and U (<P) is the user capacity (in pages). Let V be the validity of victim super block, i.e., a share of valid pages VPs in a super block that is selected for garbage collection, the invalidity of such super block is I:=1−V. The super block can be assigned as a victim according to the garbage collection cleaning policy.

Suppose that there is always one empty super block and garbage collection rewrites all valid data from the victim super block to this empty super block at once when needed and then erases the victim super block. Since a steady state is considered, such rewriting-erasure will happen many times with all super blocks. Consider a discrete process of pages invalidation under random write workload, so that one moment in time corresponds to the invalidation of one page.

Denote by t=0 a moment of time just after garbage collection (note that this moment is far away from the start of the SSD work, when it has already been transferred to steady state). All super blocks with i will be enumerated from 1 (corresponding to an open target super block) to m (corresponding to a super block that was a victim and became empty just after garbage collection), i.e., when super blocks are sorted in a linear way by the time of the last erasure. Denote at the moment t by Vᵢ(t) the validity of the VPs of the i-th super block, kᵢ(t)=nVᵢ(t) is an average number of VPs in the i-th super block, and initial values are:

$${V}_{i} := {V}_{i} ( 0 ) , {k}_{i} := {k}_{i} ( 0 ) , ( {V}_{1} = V , {V}_{m} = {k}_{m} = 0 ) .$$

Due to the sorting, we have inequalities for arbitrary t:

$${V}_{i - 1} ( t ) > {V}_{i} ( t ) , {k}_{i - 1} ( t ) > {k}_{i} ( t ) , i = \overline{2 , m} .$$

Since in a steady state garbage collection happens at discrete moments in time t=inI, i=0, 1, 2, . . . on average, the following system of equalities is valid:

$${k}_{i} := {k}_{i} ( {t}_{0} ) = {k}_{i - 1} ( {t}_{1} ) = … = {k}_{1} ( {t}_{i - 1} ) , i = \overline{1 , m - 1} , {k}_{m} = 0. \qquad ( 1 )$$

Invalidation of a page in an open super block at moment t occurs with probability q(t)=k₁(t−1)/U since the frequency of invalidation is proportional to the remaining VPs in a given super block, and in this case, a new data chunk is written in the same open super block, so its validity does not change. Invalidation of a page in any other closed super block at moment t occurs with probability 1−q(t) and in this case, the number of VPs in an open super block is incremented. Therefore, the Cauchy problem for the number k₁(t) of VPs in the open super block has the form:

$$Δ {k}_{1} ( t ) = 0 \cdot q ( t ) + 1 ( 1 - q ( t ) ) = 1 - {k}_{1} ( t - 1 ) / U , 0 \leq t \leq nI , {k}_{1} ( 0 ) = nV ,$$

where Δ is the first difference operator:

Δf(t)=f(t)−f(t−1) for any discrete function of time f(t).

The solution of the equation can be represented as:

$${k}_{1} ( t ) = ( n V - U ) {( 1 - {U}^{- 1} )}^{t} + U , 0 \leq t \leq nI . \qquad ( 2 )$$

For all other closed super blocks, the number kᵢ(t) of valid pages VPs can only decrease. The corresponding Cauchy problems have a cascade form, i.e., the initial values for the next super block depend on the solution for the previous SD due to (1):

$$Δ {k}_{i} ( t ) = - {k}_{i} ( t - 1 ) / U , 0 \leq t \leq nI , {k}_{i} ( 0 ) = {k}_{i - 1} ( nI ) , i = \overline{2 , m - 1} . \qquad ( 3 )$$

$$Then ,$$

$${k}_{i} ( t ) = {K ( 1 - {U}^{- 1} )}^{( i - 2 ) nI + t} , 0 \leq t \leq nI , i = \overline{2 , m - 1} ,$$

where the new notation is introduced:

$$K := {k}_{2} = {k}_{1} ( nI ) .$$

Note that when using the definition of effective over-provisioning, the limit relation holds:

$${( 1 - {U}^{- 1} )}^{nI} = {( 1 - \frac{a + 1}{n m} )}^{nI} {\to }_{n \to ∞} x := {e}^{- ( a + 1 ) I / m} = {e}^{- nI / U} < 1 .$$

Applying this approximation to (2) and (3), the following limits are valid:

$${k}_{i} {\to }_{n \to ∞} {Kx}^{i - 2} , i = \overline{2 , m - 1} , K {\to }_{n \to ∞} ( nV - U ) x + U .$$

Moreover, together with (1) and (3), it means that:

$${k}_{i} ( t ) = {k}_{i - 1} ( t ) x , {k}_{i} ( t + nI ) = {k}_{i} ( t ) x , i = \overline{2 , m - 1} .$$

$${V}_{i} ( t ) = {V}_{i - 1} ( t ) x , {V}_{i} ( t + nI ) = {V}_{i} ( t ) x , i = \overline{2 , m - 1} .$$

Just before garbage collection, the validity of the last non-empty (m-1)-th super block should be equal V, i.e.:

$${k}_{m - 1} ( nI ) = {k}_{m - 1} x = {Kx}^{m - 2} = nV .$$

Thus, considering that K=K(V), x=x(V) are functions of V, the validity of a victim super block can be found from the transcendental equation:

$$K ( V ) {x}^{m - 2} ( V ) = nV . \qquad ( 4 )$$

With V and x=e^{-n(1-V)/U} it is possible to derive kᵢ, Vᵢ by the formulas:

$${k}_{1} = n V , {k}_{i} = {k}_{i - 1} x , {V}_{i} = {V}_{i - 1} x , i = \overline{2 , m - 1} , {k}_{m} = {V}_{m} = 0. \qquad ( 5 )$$

An embodiment of the present disclosure allows simulating a high-capacity drive for target performance metrics estimation with very low DRAM consumption for storing mapping table.

In addition, an embodiment of the present disclosure allows reducing search time of suitable product parameters to satisfy target requirements due to multiple simulations running in parallel and due to the reduced time for precondition generation for each simulation.

Although the foregoing embodiments have been illustrated and described in some detail for purposes of clarity and understanding, the present invention is not limited to the details provided. There are many alternative ways of implementing the invention, as one skilled in the art will appreciate in light of the foregoing disclosure. The disclosed embodiments are thus illustrative, not restrictive. The present invention is intended to embrace all modifications and alternatives of the disclosed embodiments. Furthermore, the disclosed embodiments may be combined to form additional embodiments.

Indeed, embodiments of the subject matter and the functional operations described in the present disclosure can be implemented in various systems, digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices. The processor and the memory can be supplemented by, or incorporated in, special purpose logic circuitry.

While the present disclosure contains many specific embodiments, these should not be construed as limitations on the scope of any invention or of what may be claimed, but rather as descriptions of features that may be specific to particular embodiments of particular inventions. Certain features that are described in the present disclosure in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations, one or more features from a combination can in some cases be excised from the combination, and the combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

Only a few embodiments and examples are described and other embodiments, enhancements and variations can be made based on what is described and illustrated in the present disclosure.

What is claimed is:

1. A method of simulating an operation of a nonvolatile memory device in a steady state, the method comprising:
initializing a target set of system data (TSSD) by simulating the steady state; and
mimicking an access to the TSSD by simulating a target workload of the nonvolatile memory device in the simulated steady state with a reduced image (RI) for the TSSD, wherein:
the TSSD includes one or more system data entities (SDEs) affected by one or more of the target workload and a target precondition;
each of the SDEs includes one or more of a set of counters including at least one of an erase counter and read counter, which control one or more physical states of the nonvolatile memory device during a lifetime of the nonvolatile memory device, a logical-to-physical (L2P) table and a physical-to-logical (P2L) table for managing physical access to data stored in the nonvolatile memory device;
the RI includes a set of one or more reduced entities (REs), each of which includes a set of one or more numerical values representing the TSSD;
the target workload includes one or more operations of accessing the nonvolatile memory device in the simulated steady state; and
the target precondition includes a predetermined number of operations which access the nonvolatile memory device to simulate the steady state.

2. The method of claim 1, further comprising measuring, as a target metric, a requirement for the nonvolatile memory device in the simulated steady state as a result of the mimicking of the access to the TSSD.

3. The method of claim 2, wherein the requirement for the nonvolatile memory device includes at least one of quality of service (QoS), throughput, power consumption, data reliability and command latency distribution of the nonvolatile memory device in the simulated steady state.

4. The method of claim 2, wherein initializing the target set of the TSSD includes defining the target metric, the target precondition and the target workload.

5. The method of claim 4, wherein initializing the target set of the TSSD further includes:
defining a ‘k’ number of firmware algorithms with indices {i₁, . . . , iₖ} to be executed during the target workload;
defining an ‘l’ number of SDEs with indices {j₁, . . . , jₗ} to be utilized by the ‘k’ number of firmware algorithms with indices {i₁, . . . , iₖ} during the target workload;
selecting, as the TSSD, a set of a ‘p’ number of SDEs with indices {s₁, . . . , sₚ} for the target precondition from the ‘l’ number of SDEs with indices {1, . . . , jₗ};
selecting, according to the TSSD, a ‘t’ number of firmware algorithms with indices {a₁, . . . , aₜ} from the ‘k’ number of firmware algorithms with indices {i₁, . . . , iₖ};
replacing the TSSD with the RI; and
initializing the RI.

6. The method of claim 5, wherein the mimicking of the access to the TSSD includes defining information representing at least one of:
an identifier of a firmware algorithm selected from the ‘t’ number of firmware algorithms with indices {a₁, . . . , aₜ};
a request type for accessing at least one SDE selected from the ‘p’ number of SDEs with indices {s₁, . . . , sₚ};
an identifier of the selected SDE from the ‘p’ number of SDES with indices {s₁, . . . , sₚ}; and
a value for updating the selected SDE.

7. The method of claim 6, wherein mimicking the access to the TSSD includes simulating the target workload according to the defined information.

8. The method of claim 7, wherein mimicking the access to the TSSD further includes updating the RI as a result of simulating the target workload.

9. A memory system comprising:
a nonvolatile memory device; and
a control circuitry configured to simulate an operation of the nonvolatile memory device in a steady state by initializing a target set of system data (TSSD) by simulating the steady state and mimicking an access to the TSSD by simulating a target workload of the nonvolatile memory device in the simulated steady state with a reduced image (RI) for the TSSD, wherein:
the TSSD includes one or more system data entities (SDEs) affected by one or more of the target workload and a target precondition;
each of the SDEs includes one or more of a set of counters including at least one of an erase counter and read counter, which control one or more physical states of the nonvolatile memory device during a lifetime of the nonvolatile memory device, a logical-to-physical (L2P) table and a physical-to-logical (P2L) table for managing physical access to data stored in the nonvolatile memory device;
the RI includes a set of one or more reduced entities (REs), each of which includes a set of one or more numerical values representing the TSSD;
the target workload includes one or more operations of accessing the nonvolatile memory device in the simulated steady state; and
the target precondition includes a predetermined number of operations of accessing the nonvolatile memory device to simulate the steady state.

10. The memory system of claim 9, the control circuitry simulates the operation further by measuring, as a target metric, a requirement for the nonvolatile memory device in the simulated steady state as a result of mimicking the access to the TSSD.

11. The memory system of claim 10, wherein the requirement for the nonvolatile memory device includes at least one of quality of service (QoS), throughput, power consumption, data reliability and command latency distribution of the nonvolatile memory device in the simulated steady state.

12. The memory system of claim 10, wherein initializing the target set of the TSSD includes defining the target metric, the target precondition and the target workload.

13. The memory system of claim 12, wherein initializing the target set of the TSSD further includes:
defining a ‘k’ number of firmware algorithms with indices {i₁, . . . , iₖ} to be executed during the target workload;
defining an ‘l’ number of SDEs with indices {j₁, . . . , jₗ} to be utilized by the ‘k’ number of firmware algorithms with indices {i₁, . . . , iₖ} during the target workload;
selecting, as the TSSD, a set of a ‘p’ number of SDEs with indices {s₁, . . . , sₚ} for the target precondition from the ‘l’ number of SDEs with indices {j₁, . . . , jₗ};
selecting, according to the TSSD, a ‘t’ number of firmware algorithms with indices {a₁, . . . , aₜ} from the ‘k’ number of firmware algorithms with indices {i₁, . . . , iₖ};
replacing the TSSD with the RI; and
initializing the RI.

14. The memory system of claim 13, wherein mimicking the access to the TSSD includes defining information representing at least one of:
an identifier of a firmware algorithm selected from the ‘t’ number of firmware algorithms with indices {a₁, . . . , aₜ};
a request type for accessing at least one SDE selected from the ‘p’ number of SDEs with indices {s₁, . . . , sₚ};
an identifier of the selected SDE from the ‘p’ number of SDEs with indices {s₁, . . . , sₚ}; and
a value for updating the selected SDE.

15. The memory system of claim 14, wherein mimicking the access to the TSSD includes simulating the target workload according to the defined information.

16. The memory system of claim 15, wherein mimicking the access to the TSSD further includes updating the RI as a result of simulating the target workload.
